(19) United States
(12) Patent Application Publication
(10) Pub. No.: US 2022/0235467 A1
(43) Pub. Date: Jul. 28, 2022

(54) ELECTROLESS METAL COATINGS EXHIBITING WAVE PERMEABILITY AND METHOD FOR THE MANUFACTURE THEREOF

(71) Applicant: FUNDACIÓN CIDETEC, Donostia-San Sebastián (ES)

(72) Inventors: Asier SALICIO PAZ, Donostia-San Sebastián (ES); Eva GARCÍA LECINA, Donostia-San Sebastián (ES); Egoitz LUIS MONASTERIO, Donostia-San Sebastián (ES)

(21) Appl. No.: 17/610,604

(22) PCT Filed: May 15, 2020
(86) PCT No.: PCT/EP2020/063625

§ 371 Date: Nov. 11, 2021

(30) Foreign Application Priority Data
May 17, 2019 (EP) 19382390.3

(51) Int. Cl. C23C 18/36; C23C 18/16; C23C 18/30; C23C 18/28; C23C 18/40; C23C 18/44

(52) U.S. Cl. CPC C23C 18/36; C23C 18/1641; C23C 18/1691; C23C 18/44; C23C 18/285; C23C 18/40; C23C 18/30

(57) ABSTRACT

It is provided a method for manufacturing a metal coated substrate by forming a metal coating on a surface of a substrate, comprising: immersing the substrate in a palladium/tin colloidal solution; immersing the substrate in an acid solution; carrying out electroless metal plating in order to obtain a continuous film-coated substrate, and subjecting the metal coating to a cryogenic treatment step in order to make it permeable to electromagnetic waves, the cryogenic treatment step being carried out by cooling the substrate with liquid nitrogen. It is also provided a metal coated substrate obtainable by the mentioned method and an article of manufacture made of the metal coated substrate.

This application claims the benefit of European Patent Application 19382390.3 filed on May 17, 2019.

### TECHNICAL FIELD

The present disclosure relates to the field of wave permeable decorative articles. In particular, it relates to a wave permeable decorative metal coating, to a method for forming this metal coating on a substrate, and to an article of manufacture having a wave permeable decorative metal coating.

### BACKGROUND ART

In recent years, in order to detect the distance or the relative speed between a vehicle and the vehicle in front, a millimeter wave radar device for distance measurement is installed in a center front position of the vehicle behind the front grill of the vehicle, an emblem, or the like.

In case of the front grill, emblems or the like a metallic coating is applied over the base material for corrosion protection and decorative purposes. The base material is usually a non-conductive resin whereas the metallic layer is commonly a copper-nickel-chromium multilayer coating, in which chromium is placed as the outer layer. However, the metal nature and the coating thickness of the multilayered coating make the latter to be not wave permeable as the metallic coating will block or greatly attenuate the travelling waves. For this reason, in order the wave radar device can perform its function, the metal coating, which is on the millimeter wave path of the radar device, must be transparent to millimeter waves.

Most metal coatings have insufficient millimeter wave permeability because, in order to have the required metallic luster, they must be continuous layers having a sufficient thickness.

Millimeter wave permeable metallic coatings are usually made of indium and are not in the form of a continuous film but of fine islands forming a discontinuous coating by, for example, vacuum evaporation or sputtering (cf. EP1707988A1). An indium coating film formed of island-like indium deposited portions and non-deposited portions on a nonconductive substrate provides the required metallic luster appearance and the gap between the islands acts as a millimeter wave transmission path.

However, indium is expensive, and it is enclosed in the list of critical raw materials for the EU, published by the European Commission. Besides, the most common methods to deposit indium on the suitable substrate are vacuum evaporation or sputtering, which require large scale equipment and complex apparatus, and are time consuming and costly. Additionally, owing to its characteristics, by these methods it is possible to obtain a metal layer with a uniform thickness when the surface is two-dimensional and has a simple flat shape, but when the surface has a complicated three-dimensional shape, obtaining homogeneous metallic thickness over the entire component surface becomes very challenging, increasing equipment cost, processing time and limiting production throughput. These facts limit industrial deployment of this technology, raising the final price of the coated component.

As a most cost-effective option, JP2011163903 discloses the use of other metals such as nickel for the same purpose. Additionally, this document discloses a chemical deposition process that allows forming on the surface of a substrate a decorative metal coating wherein, in order to make it permeable to electromagnetic waves, cracks are induced by heat treatment. However, the presence of cracks eases the corrosion of the coating.

Thus, there is still a need to provide new methods for covering a base material with a metal coating having the required electromagnetic wave permeability and metallic luster appearance, particularly having a specular shine, and without the drawbacks of the metal coatings already known.

### SUMMARY OF INVENTION

Inventors have found that by carrying out the method of the invention, wherein, first, a nickel coating is formed on the surface of a substrate and, then, the coating is subjected to a cryogenic treatment step by cooling the coated substrate with liquid nitrogen, a metal coating with a particularly good performance in terms of millimeter wave permeability (lower attenuation) and having an excellent metallic luster appearance is obtained. Thus, a metal coating can be formed on a surface of a substrate to obtain a decorative coated substrate that is permeable to electromagnetic waves such as radar waves and thus that can be used in the beam path of a radar device.

Thus, one aspect of the present invention relates to a method for manufacturing a metal coated substrate by forming a metal coating on a surface of a substrate, comprising the following steps:

a) carrying out a sensitization step by:
immersing the substrate in a colloidal palladium/tin colloidal solution;
immersing the substrate in a tin aqueous solution and, thereafter, in a palladium aqueous solution, or vice versa; or
depositing on the substrate a catalitically active metallic nuclei such as a silver nucleus by immersion or a spray method;

b) immersing the substrate in an acid solution;

c) optionally, immersing the substrate in a PdCl solution;

d) carrying out electroless metal plating by immersing the substrate in a metal electrolyte solution to form a metal coating on the surface of the substrate in order to obtain a continuous film-coated substrate, wherein the metal electrolyte solution comprises a source of metal cations, a complexing agent and a reducing agent, and wherein electroless metal plating is carried out for 5 to 300 seconds, and the metal coating formed has a thickness from 50 to 175 nm; and

e) subjecting the metal coating to a cryogenic treatment step by cooling the continuous film-coated substrate with liquid nitrogen.

The method of the present disclosure allows carrying out electroless metallization on several substrates such as polycarbonate without the necessity of complicated pretreatments to preconditioning of the surface, thus, allowing simplification of the conventional electroless processes commonly used up to now, to obtain a decorative, homogeneous and defect-free coating with a desired thickness. This metal coating is useful in specific applications wherein permeability to certain electromagnetic waves such as in illumination is sought.

Additionally, by carrying out the cryogenic treatment step in liquid nitrogen the coating layer is made permeable to electromagnetic waves such as radar waves, while the appearance of a continuous and homogeneous layer to the naked eye is maintained.

As observed in FIG. 1b, by the treatment with N₂, no cracks are observed in the metal coating, conversely to what is observed by the thermal treatment of the same coating where a surface cracking is observed (see FIG. 2). Nevertheless, unexpectedly the millimeter wave permeability is lower (greater attenuation) in samples subjected to a thermal treatment than to a cryogenic treatment with N₂. Additionally, the absence of cracks in the coated substrates obtained by the process of the present disclosure minimizes the problem of corrosion of the coating, what allows maintaining the luster appearance during longer periods of time.

Another aspect of the invention relates to the metal coated substrate obtainable by the process of the invention.

Another aspect of the invention relates to the use of a metal coated substrate as defined herein above and below for concealing radar antennas, sensors, image recording systems, or illumination systems. Thus, the metal coated substrate of the invention is useful for the production of an article of manufacture comprising a radar antenna, a sensor, an image recording system, or an illumination system.

The invention also concerns to an article of manufacture made of the metal coated substrate of the invention.

The article can be manufactured by a process comprising forming said article from a metal coated substrate obtainable by the process of the invention. The article can be obtained by methods known in the art.

### BRIEF DESCRIPTION OF DRAWINGS

FIG. 1 shows the image of the electroless nickel coating of sample ref. LP-1 of Example 1 both before (FIG. 1a) and after (FIG. 1b) liquid nitrogen treatment. The images were obtained by Field Emission Scanning Electron Microscope (Zeiss, Ultra-Plus FESEM) operated at 3 kV at a magnification of about 50,000×.

FIG. 2 shows the image of the electroless nickel coating of a sample obtained as ref. LP-1 of Example 1 after thermal annealing at 75° C. during 1 hour in order to promote surface cracking. The image was obtained by FESEM operated at 3 kV at a magnification of about 25,000×.

FIG. 3 shows the image obtained X-Ray diffraction as explained in Example 3.

### DETAILED DESCRIPTION OF THE INVENTION

All terms as used herein in this application, unless otherwise stated, shall be understood in their ordinary meaning as known in the art. Other more specific definitions terms as used in the present application are as set forth below and are intended to apply uniformly throughout the specification and claims unless an otherwise expressly set out definition provides a broader definition.

In physics, electromagnetic radiation refers to the waves of the electromagnetic field, propagating (radiating) through space, carrying electromagnetic radiant energy. Electromagnetic waves are classified according to their frequency, so it includes radio waves, microwaves, infrared, (visible) light, ultraviolet, X-rays, and gamma rays.

As used herein, the term “radar waves” refers to waves used in a radar detection system, that is to electromagnetic waves in the radio domain, i.e. to radio waves. Radio waves used by radar have wavelengths in the electromagnetic spectrum longer than infrared light. Radio waves have frequencies as high as 300 gigahertz (GHz) to as low as 30 hertz (Hz).

As used herein, the term “homogeneous layer” or “homogeneous coating”, used herein interchangeably refers to a layer or coating covering all the surface of the substrate, namely, the 100% of the surface, and having a uniform thickness and composition.

It is noted that, as used in this specification and the appended claims, the singular forms “a”, “an” and “the” include plural referents unless the context clearly dictates otherwise.

As mentioned above, the metallization process of substrates of the present invention is a multistep process comprising several steps addressed to prepare the surface of the substrate in such a way that the electroless nickel plating allows forming a coating that is permeable to electromagnetic waves, while having the required mechanical properties and a good adhesion with the substrate.

Previously to step a), a surface cleaning can be performed, for instance, by treatment with a detergent and rinsing or by treatment with a degreasing solution such as an acid or alkali solution, or a degreasing agent. Detergents, degreasing solutions and degreasing agents suitable for the mentioned surface cleaning are already known and commercially available.

As mentioned above, a sensitization step (step a) is carried out by immersing the substrate in a colloidal palladium/tin solution. Alternatively, the substrate can be immersed in a tin aqueous solution and, thereafter, in a palladium aqueous solution, or vice versa. Examples of commercially available colloidal palladium/tin solutions are Neolink Activator (Atotech), Macuplex D-34 (MacDermid), and Silken Catalyst 501 (Coventya). The objective of the sensitization step is to render active places over the substrate surface so the electroless process can be initiated on the metallic nuclei. It is possible to perform the sensitization step with other metallic nuclei catalytically active towards the electroless process such as silver, tin or the like. These metallic nuclei can be deposited by immersion, or a spray method.

Subsequently, an acceleration step (step b) is carried out with an accelerator solution which is an aqueous solution of an acid. The acid can be selected, for example, from the group consisting of sulfuric acid, hydrochloric acid, citric acid and tetrafluoroboric acid. In the case of a palladium/tin colloid, the accelerator solution helps to remove the tin compounds which served as the protective colloid. Examples of commercially available commonly used accelerator solutions are Adhemax Accelerator (Atotech), Macuplex GS-50 (MacDermid), and Silken Accelerator 602 (Coventya).

After the acceleration step, an activation step (step c) can be optionally carried out by immersing the substrate in a PdCl solution adjusted to acid pH (i.e. a pH less than 7) by the addition of HCl. Particularly, the amount of PdCl in the solution can be from 0.1 to 0.5 g/L, and the pH is from 1 to 4.

Electroless plating allows depositing a homogeneous metallic layer on a substrate which can be either a conductive material or an insulator (i.e. non-conductive) material. The resulting metallic coating is in fact an alloy, as part of the reducing agent is co-deposited along with the metal. The metallic layer, when deposited sufficiently thin and homogeneous, becomes permeable to electromagnetic waves such as radar waves after being properly treated.

In an embodiment, the immersion of the substrate in a colloidal palladium/tin colloidal solution (step a) is carried out for 5 to 20 min, or for 12 to 17 min, particularly for 15 min.

In another embodiment, optionally in combination with one or more features of the embodiments defined above, electroless coating (i.e. step d) is carried out for for 10 to 30 seconds, more particularly for for 10 to 20 seconds or 10 to 15 seconds, even more particularly for 10 seconds. This allows obtaining a metal coating having a thickness from from 75 to 150 nm. Particularly, the metal coating is a homogeneous coating having a uniform thickness and composition.

The metal constituting the coating layer can be nickel, a nickel alloy, copper, a copper alloy, silver, a silver alloy, tin, and a tin alloy. Particularly, the metal is nickel or a nickel alloy. In the electroless metal plating step, the electroless plating solution will contain an appropriate metal depending on the type of the metal coating formed on the surface of the substrate. As a consequence, electroless metal plating will be carried out in a bath of an electrolyte solution (also called electroless plating bath) basically comprising a source of cations of the corresponding metal or metals, a complexing agent, and a reducing agent.

Thus, in an embodiment, optionally in combination with one or more features of the embodiments defined above, the metal coating is selected from the group consisting of a nickel, a nickel alloy, a copper, a copper alloy, a silver, a silver alloy, a tin, and a tin alloy coating, and the electrolyte solution comprises a source of metal cations wherein the metal cations are selected from the group consisting of nickel cations, copper cations, silver cations, tin cations, and mixtures thereof. Particularly, the metal coating is a nickel coating, or a nickel alloy coating and the electrolyte solution comprises a source of nickel cations.

As an instance, electroless nickel plating can be carried out in an electroless plating bath containing a source of nickel cations, a complexing agent such as glycine, and a hypophosphite reducing agent.

Examples of nickel compounds useful as source of nickel cations include nickel sulfate (anhydrous or hydrated), nickel hypophosphite, nickel sulfamate nickel carbonate, nickel chloride or a combination thereof. Normally, hydrated nickel sulfate is preferred. Typically, in order to get a nickel or nickel alloy coating the electroless plating bath has a nickel ions concentration of from 3 g/L to 20 g/L, particularly from 5 g/L to 10 g/L.

Examples of reducing agents include hypophosphite salts such as hypophosphite alkali metal salts, particularly sodium hypophosphite. More particularly, the reducing agent is a hypophosphite salt and it is in an amount from 15 to 75 g/L, particularly from 20 to 40 g/L.

Examples of complexing agents include acetate ethylendiamine, malate, citrate, glycine, and lactate. Particularly, the complexing agent can be in an amount from 1 to 60 g/L, particularly from 20 to 30 g/L.

The electroless plating bath can also comprise a stabilizer such as lead, cadmium, sulfur, and thiourea. Particularly, the stabilizer can be in an amount from 1 ppm to 10 ppm.

As used herein, the term “low phosphorus (LP) coating” refers to a coating comprising phosphorous in an amount from 1 to 4 wt % related to the total weight coating.

As used herein, the term “high phosphorus (HP) coating” refers to a coating comprising phosphorus in an amount from 10 to 25 wt %, particularly from 10 to 14 wt %, related to the total weight coating.

As used herein, the term “medium phosphorus (MP) coating” refers to a coating comprising phosphorus in an amount from 5 to 9 wt % related to the total weight coating.

The amount of phosphorus in the final coating will depend on the concentration of the source of phosphorus (such as sodium hypophosphite) in the electrolyte solution, the pH of this electrolyte solution, and the presence and amount of complexing agent. A skilled person in the art will know which concentration of the source of phosphorus, the amount of complexing agent and the pH of the solution in order to obtain the sought amount of phosphorus in the final coating.

The deposition reaction takes place in the bath and generally involves the reduction of a nickel cation to form a nickel coating on the desired substrate surface.

In an embodiment, optionally in combination with one or more features of the embodiments defined above, the electrolyte solution is an electrolyte solution capable of providing a low phosphorus (LP) coating. Electrolyte solutions capable of providing a LP coating are commercially available. Examples of electrolyte solution capable of providing a LP coating are Niklad ELV 824 (from Macdermid Enthone Industrial Solutions), Nichem® (from Atotech), and Enova EF 243 (from Coventya). As an instance, the LP electrolyte solution comprises from 15 to 30 g/L of a hypophosphite salt and from 1 to 40 g/L of a complexing agent, and has a pH from 6 to 8. The amount of source of nickel cations is such that the amount of nickel ions is from 3 g/L to 20 g/L, particularly from 3 g/L to 10 g/L. LP coatings exhibit a nano crystalline structure and allow a higher plating rate and a better coverage of the surface of the substrate, as well as a better control of the thickness of the coating applied onto the surface of the substrate.

In another embodiment, optionally in combination with one or more features of the embodiments defined above, the electrolyte solution is an electrolyte solution capable of providing high phosphorus (HP) coating. Electrolyte solutions capable of providing a HP coating are commercially available. As an instance, Macuplex M550 (from Macdermid Enthone Industrial Solutions) can be used.

As mentioned above, the cryogenic treatment step was carried out by immersing the nickel-coated substrate in liquid nitrogen, i.e. at −196° C. In an embodiment, optionally in combination with one or more features of the embodiments defined above, cooling in the cryogenic treatment step is performed for 10-600 seconds, particularly for 60, 200, 300, or 400 seconds.

The substrate is made of a suitable material such as a resin having a small radar wave transmission loss.

Examples of resins include acrylonitrile-butadiene-styrene (ABS), acrylonitrile ethylene styrene (AES), polymethyl methacrylate (PMMA), polyurethane resins, polyamide, polyurea, polyester resins, polyether ether ketones, polyvinyl chloride resins, polyether sulfones (PES), cellulose resins, and polycarbonate (PC), copolymers and mixtures thereof (such as ABS+PC). Note that these resin-based materials are listed as examples and many others thermosetting and/or thermostable resin could be used as suitable substrates. Particularly the substrate is PC. The substrate is in the form of a molded article, which can be manufactured by any conventional method, such as melt molding or casting. The substrate is not limited to resins, but it would be also possible to apply the coating on transparent substrates like glass or semiconductors such as ITO (indium-tin-oxide), conducting polymers such as poly(3,4-ethylenedioxythiophene) (PEDOT).

Thus, in another embodiment, optionally in combination with one or more features of the embodiments defined above, the substrate is a material exhibiting small radar wave transmission loss such as thermosetting and/or thermostable resins, glass, semiconductor materials or a combination thereof.

The thickness of the substrate is not relevant provided it is transparent to electromagnetic waves in the radio domain (i.e. radar waves) or has a higher permeability to electromagnetic waves than the metal coating. Particularly, electromagnetic waves are radar waves, more particularly electromagnetic waves in the frequency range from 70 MHz to 85 MHz.

The metal coated substrate obtainable by the process of the present disclosure provides an attenuation for electromagnetic waves in the frequency range from 70 MHz to 85 MHz which is more than 50% lower than the attenuation of the metal coated substrate as-deposited (i.e. after the electroless metal plating step of the process as defined above, but without carrying the cryogenic treatment step). Additionally, attenuation is significantly lower than the one obtained by the processes disclosed in the prior art, where a thermal treatment with the consequent cracking of the coating surface is carried out in order to allow the required attenuation. Measurement of the transmission of millimeter waves (given as attenuation values) was carried out using a quasi-optical bench with focusing lens attached and equipped with vector network analyzer Keysight PNA-X E3861 attached with VDI frequency extender for W band, as explained in the examples below.

Thus, in an embodiment, optionally in combination with one or more features of the embodiments defined above, metal coated substrate obtainable by the process of the present disclosure provides an attenuation for electromagnetic waves in the frequency range from 70 MHz to 85 MHz, such as for milllimeter waves of 77 MHz, lower than 7 dB, particularly from 0.1 to 6, more particularly from 3 to 5.5 dB, as measured as disclosed herein above. More particularly, the attenuation at the mentioned millimeter waves is from 3 to 4 dB.

Surprisingly, no cracks were observed in the obtained metal coating when images were obtained by FESEM operated at 3 kV at a magnification of about 50,000×.

In an embodiment, optionally in combination with one or more features of the embodiments defined above, step a) is carried out for 5 to 20 min, and wherein in step d) the metal electrolyte solution is a nickel electrolyte solution, the reducing agent is a hypophosphite alkali metal salt, and electroless plating is carried out for 5 to 300 seconds at a temperature from 40 to 80° C. in an electroless nickel electrolyte solution at a pH from 4 to 10 in order to obtain a coating with a phosphorous content from 1-25 wt %, particularly of 1 to 14 wt %, related to the total weight coating.

In another embodiment, optionally in combination with one or more features of the embodiments defined above, step a) is carried out for 12 to 17 min, and wherein in step d) the metal electrolyte solution is a nickel electrolyte solution, the reducing agent is a hypophosphite alkali metal salt, and electroless plating is carried out for 5 to 20 seconds at a temperature from 65 to 75° C. at a pH from 6 to 7 in order to obtain a coating with a phosphorous content from 1 to 4 wt % related to the total weight coating. In a more particular embodiment, step a) is carried out for 15 min, an electroless plating is carried out for 10 seconds at a temperature from 70 to 75° C. in a nickel electrolyte solution at a pH of 6.5.

The coating with a low phosphorous content, i.e. with a phosphorous content from 1 to 4 wt %, exhibit a nanocrystalline structure. The coating microstructure can be measured by X-ray diffraction (Bruker, D8) using CuKα radiation (λ=1.5418 Å) in the Bragg Brentano geometry. Crystallite size can be measured using the Scherrer's equation which is implemented in the EVA Software® (Bruker) of the diffractometer. Measurement range was 20-100° C. The Scherrer's equation is applied in the most intense reflection for the face centered cubic (fcc) nickel phase (according to PDF 065-2865) corresponding to the (111) reflection. Thus, in a more particular embodiment, the electroless nickel coating has a structure containing crystallites having a size of up to 10 nm, such as from 2 to 10 nm, calculated by the Scherrer's equation by X-ray diffraction with CuKα radiation (λ=1.5418 Å) in the Bragg Brentano geometry. As mentioned above, by carrying out the electroless plating with an electrolyte solution providing a low phosphorous content, a higher plating rate and a better coverage of the surface of the substrate are, as well as a better control of the thickness of the coating applied onto the surface of the substrate are provided.

In another embodiment, optionally in combination with one or more features of the embodiments defined above, step a) is carried out for 12 to 17 min, and in step d) the metal electrolyte solution is a nickel electrolyte solution, the reducing agent is a hypophosphite alkali metal salt, and electroless plating is carried out for 15 to 60 seconds, particularly for 25 to 35 seconds, at a temperature from 40 to 60° C. in an electroless nickel electrolyte solution having a a pH of 8 to 10 in order to obtain a coating with a high phosphorous content, i.e. with a phosphorous content from 10 to 25 wt %, particularly from 10 to 14 wt %, related to the total weight coating. This coating exhibits an amorphous structure. In a more particular embodiment, optionally in combination with one or more features of the embodiments defined above, step a) is carried out for 15 min, an electroless plating is carried out for 30 seconds at a temperature from 60° C. in a nickel electrolyte solution at a pH of 9.

As commented above, an inherent result of the process of the invention is that it provides metal coatings with a particularly good performance in terms of permeability to electromagnetic waves, particularly to radar waves, having an excellent metallic luster appearance, and having a high corrosion resistance. Thus, a metal coating can be formed on a surface of a substrate to obtain a decorative coated substrate that is permeable to electromagnetic waves such as radar waves and thus that can be used in the beam path of a radar device.

These properties make the metal coated substrate of the invention particularly suitable for the production of different articles of manufacture for multiple applications, including some applications of the automotive and aerospace industry such as a radome for a radar system. As an instance, the metal coated substrate of the invention can be placed in front of a camera device such as an automotive reversing camera keeping it hidden from the naked eye while maintaining its metallic appearance. However, general uses are not limited to the former and may include any potential application that requires concealed radar antennas, sensors, image recording systems, or illumination systems.

As mentioned above, the invention also concerns to an article of manufacture made of the metal coated substrate of the invention.

In an embodiment, the article of manufacture comprises a radar antenna.

In another embodiment, the article of manufacture comprises a sensor such as a light sensor.

In another embodiment, the article of manufacture is for image recording. Particularly, it is an automotive reversing camera.

In an embodiment, the article of manufacture is for illumination applications.

Such improved properties indicate that the metal coated substrate and article of manufacture obtained there from are different to the already known in the prior art.

Throughout the description and claims the word “comprise” and variations of the word, are not intended to exclude other technical features, additives, components, or steps. Furthermore, the word “comprise” encompasses the case of “consisting of”.

The following examples and drawings are provided by way of illustration, and they are not intended to be limiting of the present invention. Furthermore, the present invention covers all possible combinations of particular and preferred embodiments described herein.

### EXAMPLES

### General Procedure

Polycarbonate (PC) substrates (70×50×2 mm) were cleaned with a commercially available detergent and gently rinsed before surface sensitization. To make the surface active towards the electroless metal plating process, a metallic seeding step (sensitization step) was carried out by immersing the substrate in a commercially available colloidal Pd/Sn solution (Neolink Activator, Atotech Deutchland GMbH), which was held at 30° C. without stirring for a time interval of 1-20 min. After the metallic seeding the PC substrates were removed from the sensitization bath and rinsed with deionized water. In order to remove the excess of metallic catalyst, the sample was subjected to an accelerator stage using an acid-based solution (Adhemax accelerator, Atotech Deutchland GMbH). The accelerating solution worked at 48° C. under magnetic stirring for 2 minutes. After the accelerating stage, the sample was cleaned with deionized water and immersed in an electroless nickel solution.

The electroless nickel solution contained nickel sulfate, sodium hypophosphite, glycine as main complexing agent, and a stabilizer to produce a low phosphorus nickel coating.

Once the electroless plating was finished, the PC substrate was removed from the electroless plating bath, gently rinsed with deionized water and dried by air blowing. Then a cryogenic treatment step was carried out by immersing the nickel-coated PC substrate in liquid nitrogen at −196° C. during 10 to 300 seconds. Without wishing to be bound by theory, it is believed that the cryogenic treatment can lead to a structural modification at the nano-scale on the metal layer that make it permeable to radar waves while maintaining a metallic luster appearance to the naked eye.

The surface of the nickel phosphorus coatings was studied by Field Emission Scanning Electron Microscope (Zeiss, Ultra-Plus FESEM) operated at 3 kV of accelerating voltage. Measurement of the transmission of millimeter waves was carried out using a quasi-optical bench with focusing lens attached and equipped with vector network analyzer Keysight PNA-X E3861 attached with VDI frequency extender for W band. The measurements were carried out by mounting the coated samples into the bench halfway between wave emitter and receiver. The bandwidth 70-85 MHz was selected for measuring millimeter wave permeability. Obtained values are those corresponding to the center of the radar signal bandwidth at 77 MHz. Values in the examples express the radar wave attenuation.

Depending on the solution composition, it is possible to obtain different phosphorus content in the metallic layer. Thus, for the sake of comparison, high phosphorus (HP) and low phosphorus (LP) nickel electrolyte solutions were used, leading to coatings with HP or LP contents, having different electric conductivity and stress nature.

### Example 1

### Preparation of a High Phosphorus Ni Coating

A first PC substrate was treated according to the general procedure above. The sensitization time was set at 15 min. Electroless plating was performed using a high phosphorus commercial electroless nickel electrolyte (Macuplex M550, Macdermid Enthone Industrial Solutions) of pH 9 at 60° C. under magnetic stirring for 30 seconds. A homogeneous nickel coating (sample HP-1) was obtained.

### Preparation of Low Phosphorus Ni Coatings

Several PC substrates were treated according to the general procedure above. An electroless solution comprising 25 g/L hexahydrated nickel sulfate, 30 g/L sodium hypophosphite as reducing agent and 20 g/L glycine as main complexing agent and having a pH of 6.5 was used. Electroless plating was performed at 75° C. under magnetic stirring. Sensitization times and electroless plating times are shown in the Table 1 below.

TABLE 1
Experimental set-up for LP coatings.

| | | T of | | |
|---|---|---|---|---|
| | | electroless | Sensitization | Electroless |
| | | bath | time | Ni plating |
| Sample Ref | pH | (° C.) | (min) | time (s) |
| LP-1 | 6.5 | 75 | 15 | 15 |
| LP-2 | 6.5 | 75 | 20 | 20 |
| LP-3 | 6.5 | 75 | 15 | 10 + 10 (bilayered) |

In sample reference LP-3, after 10 seconds in the electroless Ni plating bath, the substrate was removed for 1-3 seconds and later on reintroduced into the bath for another 10 seconds to apply another consecutive layer. Thus, in a total bath time of 20 seconds, 2 layers of 10 seconds each were formed.

A dense and homogeneous nickel coating was obtained for all the samples. The thickness range was between 75-150 nm as determined by Field Emission Scanning Electron Microscopy (see General Procedure).

### Radar Attenuation of Coated Substrates

The coated substrates were subjected to a cryogenic treatment step by immersing the nickel-coated substrates in liquid nitrogen at −196° C. for 60 seconds. Then, radar transparency measurements were carried out on the different coated substrates in order to check their suitability for being placed in the beam path of a radar device.

The results are shown in table 2 below.

TABLE 2
Radar attenuation values obtained before and after surface
cryogenic treatment step

| | Radar attenuation for as- | Radar attenuation after |
|---|---|---|
| Piece | deposited coatings | cryogenic treatment step |
| Ref | (dB) | (dB) |
| HP-1 | 18 | 5.15 |
| LP-2 | 11 | 4 |
| LP-3 | 15 | 4 |

In general, the HP coating offered higher radar attenuation than the LP coatings. Also the higher plating rate of the LP coatings allowed better coverage of the PC surface as well as a better control of the applied thickness onto the PC surface.

In all the examples, the radar attenuation of the coatings decreased more than 50% of the value for the as-deposited coating, as required for their better performance in the applications of the automotive industry.

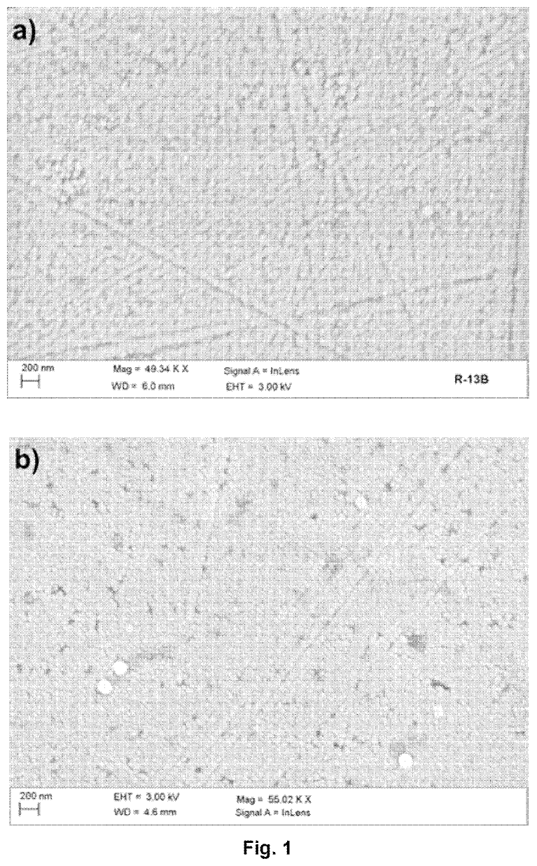

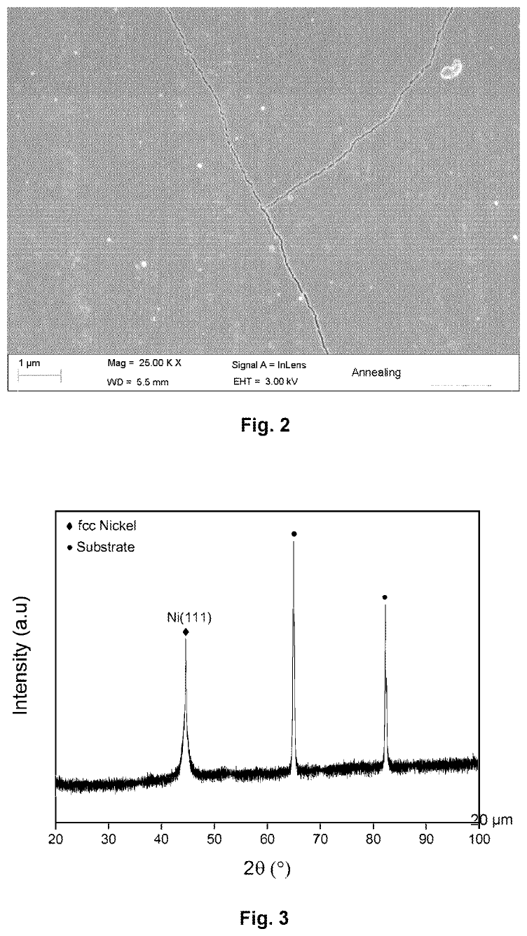

To avoid defects induced by surface preparation, a FESEM study of the surface was carried out on a PC piece of 2×2 cm nickel-coated in the same conditions as LP-1. Comparison of the sample before and after liquid N₂ treatment revealed a higher degree of defects on the surface after the cryogenic treatment. Nevertheless, no cracks were observed on the coating at a magnification of more than 50,000× (see FIGS. 1a and 1b). However, FIG. 2 shows a similar sample, which was subjected to thermal annealing at 75° C. during 1 hour in order to promote surface cracking instead of being subjected to the liquid N₂ treatment. As can be seen, several cracks can be observed in the surface.

By means of the process of the present disclosure comprising a cryogenic treatment step it is possible to obtain surfaces with a metal coating having a metallic luster appearance, particularly having a specular shine, which are highly permeable to millimeter radar waves without cracks being produced in the coating. This absence of cracks minimizes the corrosion of the coating, what allows maintaining the luster appearance during longer periods of time.

### Example 2

Several PC substrates were coated with a low phosphorous nickel coating according to the general procedure described above (Example 1) from an electroless solution at pH 6.5. The sensitization time was set at 15 min. Electroless plating was performed at 70° C. for 10 seconds under magnetic stirring. Some of the obtained samples were subjected to thermal annealing at 75° C. during 1 hour in order to promote surface cracking. For the sake of comparison, samples obtained under the same experimental set-up were subjected to a cryogenic treatment by immersion in liquid nitrogen for 5 minutes. Millimeter wave permeability (given as attenuation values) was measured in all the produced coatings. The results are shown in the Table 3 below.

TABLE 3
Radar attenuation values obtained.

| Ni/PC | Condition | Radar attenuation (dB) |
|---|---|---|
| 70° C., 10 s | As deposited | 7.8 |
| | N₂, 5 min | 3.7 |
| | 75° C., 1 h | 5 |

As shown in Table 3 surface cracking by thermal annealing of electroless Ni coated PC substrates improved millimeter wave permeability by 33%, whereas liquid N₂ surface cryogenic treatment produced a millimeter wave permeability increased higher than 50% in comparison with as-deposited coatings.

### Example 3

A low phosphorous nickel coating was obtained according to the general procedure describe above from an electroless solution at pH 6.6 and a temperature 75° C. for a total plating time of 1 min over polished low carbon steel samples. The coating microstructure was measured by X-ray diffraction (Bruker, D8) using CuKα radiation in the Bragg Brentano geometry (see FIG. 3). Crystallite size was evaluated using the Scherrer's equation which is implemented in the EVA Software® (Bruker) of the diffractometer. Measurement range was 20-100° C. The Scherrer's equation was applied in the most intense reflection for the face centered cubic (fcc) nickel phase (according to PDF 065-2865) corresponding to the (111) reflection. The remaining peaks in the diffractogram correspond to the base material. According to Scherrer's equation the calculated crystallite size for the electroless nickel coating was 8.1 nm.

### Example 4

Several PC substrate having low phosphorus Ni coatings were prepared according to the procedure of Example 1, but for the specific features shown in Table 4.

In order to evaluate the applicability of these coated substrates for camera devices, values of transmittance data were measured and are shown in Table 4. These values demonstrate the feasibility of using these coated substrates for camera devices.

TABLE 4
Transmittance values

| Processing | Electroless | Transmittance | Transmittance after |
|---|---|---|---|
| temperature | nickel | for as-deposited | cryogenic |
| (°) | plating time (s) | coatings (%) | treatment (%) |
| 65 | 30 | 10 | 10 |
| 70 | 10 | 5 | 5 |
| 75 | 15 | 3 | 3 |
| 75 | 30 | 0 | 0 |

Thus, as shown by the results, the cryogenic treatment does not affect to the transmittance. Additionally, high quality images were obtained both for the coated substrates before and after cryogenic treatment. The quality of the images obtained evidenced the suitability of the PC coated substrates to be used for hiding a camera device. Application in which a camera device is hidden behind a metallized object include as a way of example reversing cameras in automobiles, however general uses are not limited to the former and may include any potential application which requires concealed radar antennas, sensors, image recording systems, or illumination systems.

### CITATION LIST

1. EP1707988A1
2. JP2011163903

1. A method for manufacturing a metal coated substrate by forming a metal coating on a surface of a substrate, the method comprising:
a) carrying out a sensitization step by:
immersing the substrate in a colloidal palladium/tin colloidal solution;
immersing the substrate in a tin aqueous solution and, thereafter, in a palladium aqueous solution, or vice versa; or
depositing on the substrate a silver nucleus by immersion or a spray method;
b) immersing the substrate in an acid solution;
c) optionally, immersing the substrate in a PdCl solution;
d) carrying out electroless metal plating by immersing the substrate in a metal electrolyte solution to form a metal coating on the surface of the substrate in order to obtain a continuous film-coated substrate, wherein the metal electrolyte solution comprises a source of metal cations, a complexing agent and a reducing agent, and wherein electroless metal plating is carried out for 5 to 300 seconds, and the metal coating formed has a thickness from 50 to 175 nm; and
e) subjecting the metal coating to a cryogenic treatment step by cooling the continuous film-coated substrate with liquid nitrogen for 10 to 600 seconds;
wherein the substrate is either transparent to electromagnetic waves in the radio domain or has a higher permeability to electromagnetic waves than the metal coating.

2. The method according to claim 1, wherein step a) is carried out for 5 to 20 min.

3. The method according to claim 1, wherein electroless metal plating is carried out for 10 to 30 seconds, and the metal coating formed has a thickness from 75 to 150 nm.

4. The method according to claim 1, wherein the metal coated substrate provides an attenuation for electromagnetic waves in the frequency range from 70 MHz to 85 MHz lower than 7 dB as measured by using a quasi-optical bench with focusing lens attached and equipped with vector network analyzer Keysight PNA-X E3861 attached with VDI frequency extender for W band.

5. The method according to claim 4, wherein the attenuation is from 0.1 to 6 dB.

6. The method according to claim 1, wherein the metal coating is selected from the group consisting of a nickel, a nickel alloy, a copper, a copper alloy, a silver, a silver alloy, a tin, and a tin alloy coating, and the metal cations are selected from the group consisting of nickel cations, copper cations, silver cations, tin cations, and mixtures thereof.

7. The method according to claim 1, wherein the metal coating is a nickel coating, or a nickel alloy coating, and the metal cations are nickel cations.

8. (canceled)

9. The method according to claim 1, wherein the substrate is polycarbonate.

10. The method according to claim 1, wherein step a) is carried out for 5 to 20 min, and wherein in step d) the metal electrolyte solution is a nickel electrolyte solution, the reducing agent is a hypophosphite alkali metal salt, and electroless plating is carried out at a temperature from 40 to 80° C. in an electroless nickel electrolyte solution at a pH range from 4 to 10 in order to obtain a coating with a phosphorus content from 1 to 25 wt % related to the total weight coating.

11. The method according to claim 1, wherein step a) is carried out for 12 to 17 min, and wherein in step d) the metal electrolyte solution is a nickel electrolyte solution, the reducing agent is a hypophosphite alkali metal salt, and electroless plating is carried out for 5 to 20 seconds at a temperature from 65 to 75° C. in a nickel electrolyte solution at a pH of 6 to 7 in order to obtain a coating with a phosphorus content from 1 to 4 wt % related to the total weight coating.

12. The method according to claim 11, wherein the coating has a structure containing crystallites having a size of up to 10 nm calculated using the Scherrer's equation by X-ray diffraction with CuKα radiation (λ=1.5418 Å) in the Bragg Brentano geometry.

13. The method according to claim 1, wherein step a) is carried out for 12 to 17 min, and wherein in step d) the metal electrolyte solution is a nickel electrolyte solution, the reducing agent is a hypophosphite alkali metal salt, and electroless plating is is carried out for 15 to 60 seconds at a temperature from 40 to 60° C. in a nickel electrolyte solution at a pH of 8 to 10 in order to obtain a coating with a phosphorus content from 10 to 25 wt % related to the total weight coating.

14. A metal coated substrate obtainable by the method as defined in claim 1, wherein the metal coated substrate provides an attenuation for electromagnetic waves in the frequency range from 70 MHz to 85 MHz lower than 7 dB as measured by using a quasi-optical bench with focusing lens attached and equipped with vector network analyzer Keysight PNA-X E3861 attached with VDI frequency extender for W band.

15. A method for concealing radar antennas, sensors, image recording systems, or illumination systems, the method comprising providing a metal coated substrate as defined in claim 14.

16. An article of manufacture made of the metal coated substrate of claim 14.

17. The article of manufacture of claim 16 comprising a radar antenna.

18. The article of manufacture of claim 16 comprising a sensor.

19. (canceled)

20. The article of manufacture of claim 16 for image recording.

21. The article of manufacture of claim 20 that is an automotive reversing camera.

22. The article of manufacture of claim 16 for illumination applications.
